(19) United States
(12) Patent Application Publication
(10) Pub. No.: US 2025/0094313 A1
(43) Pub. Date: Mar. 20, 2025

(54) METHOD FOR IDENTIFYING UNDERLOCKING RISKS IN PUBLIC CLOUD AND ELECTRONIC DEVICE, AND STORAGE MEDIUM

(71) Applicant: Beijing Volcano Engine Technology Co., Ltd., Beijing (CN)

(72) Inventor: Pengcheng DU, Beijing (CN)

(21) Appl. No.: 18/829,013

(22) Filed: Sep. 9, 2024

(30) Foreign Application Priority Data
Sep. 19, 2023 (CN) 202311214779.2

(51) Int. Cl. G06F 11/34; G06F 11/30

(52) U.S. Cl. CPC G06F 11/3495; G06F 11/301; G06F 11/3452

(57) ABSTRACT

A method for identifying underclocking risks in a public cloud, an electronic device, and a storage medium are provided. The method includes collecting frequency fluctuations of CPU units in a host in a public cloud environment; wherein each of the CPU units includes a plurality of cores; collecting CPU utilization rates of tenant virtual machines in the host; and sifting out risky virtual machines from the tenant virtual machines according to the frequency fluctuations of the CPU units and the CPU utilization rates of the tenant virtual machines.

### CROSS-REFERENCE TO RELATED APPLICATION

The present disclosure claims priority of the Chinese Patent Application No. 202311214779.2 filed on Sep. 19, 2023, the disclosure of which is incorporated herein by reference in its entirety as part of the present application.

### TECHNICAL FIELD

The embodiments of the present disclosure relate to a method for identifying underclocking risks in a public cloud and an electronic device, and a storage medium.

### BACKGROUND

A public cloud is a cloud computing resource provided by a third-party provider to users. In a non-oversubscription scenario of public clouds, multi-tenants will generally run services by sharing different physical cores on the same host, in order to achieve flexible sale and on-demand use of resources. Public cloud providers provide basic multi-tenant isolation and security assurance, as well as specs (vendor virtual machine specifications) of expected operating frequencies.

### SUMMARY

A method for identifying underclocking risks in a public cloud, a device and a storage medium are provided in the embodiments of the present disclosure, aiming to sift out risky virtual machines that might be affected by CPU underclocking in a public cloud environment.

Embodiments of the present disclosure provides a method for identifying underclocking risks in a public cloud, including:
collecting frequency fluctuations of CPU units in a host in a public cloud environment; wherein each of the CPU units includes a plurality of cores;
collecting CPU utilization rates of tenant virtual machines in the host; and
sifting out risky virtual machines from the tenant virtual machines according to the frequency fluctuations of the CPU units and the CPU utilization rates of the tenant virtual machines.

Embodiments of the present disclosure provides a device for identifying underclocking risks in a public cloud, including:
a CPU frequency fluctuation collecting unit, configured to collect frequency fluctuations of CPU units in a host in a public cloud environment; wherein each CPU unit includes a plurality of cores;
a CPU utilization rate collecting unit, configured to collect CPU utilization rates of tenant virtual machines in the host; and
an identifying unit, configured to sift out risky virtual machines from the tenant virtual machines according to the frequency fluctuations of the CPU units and the CPU utilization rates of the tenant virtual machines.

Embodiments of the present disclosure provide an electronic device, including at least one processor and at least one memory;
the at least one memory is stored with computer executable instructions;
the at least one processor executes the computer executable instructions stored in the at least one memory, such that the at least one processor executes the method for identifying underclocking risks in a public cloud as described in the above and various possible designs of the above.

Embodiments of the present disclosure provide a non-transient computer readable storage medium. The computer executable instructions are stored in the computer readable storage medium, and the processor, when executing the computer executable instructions, implements the method for identifying underclocking risks in a public cloud as described in the above and various possible designs of the above.

Embodiments of the present disclosure provide a computer program product. A processor, when executing the computer executable instructions, implements the method for identifying underclocking risks in a public cloud as described in the above and various possible designs of the above.

### BRIEF DESCRIPTION OF DRAWINGS

In order to provide a clearer description of the technical solution in the embodiments of the present disclosure, the drawings that need to be used in the description of the embodiments will be briefly depicted below. Obviously, the drawings in the following description are some embodiments of the present disclosure. For those ordinary skilled in the art, other drawings may also be attained from these drawings without creative efforts.

FIG. 1 is a schematic diagram of identifying underclocking risks in a public cloud;

FIG. 2 is a schematic architecture diagram of a method for identifying underclocking risks in a public cloud according to an embodiment of the present disclosure;

FIG. 3 is a schematic flow diagram of the method for identifying underclocking risks in a public cloud according to an embodiment of the present disclosure;

FIG. 4 is a schematic flow diagram of the method for identifying underclocking risks in a public cloud according to another embodiment of the present disclosure;

FIG. 5 is a block diagram illustrating the structure of a device for identifying underclocking risks in a public cloud according to an embodiment of the present disclosure; and

FIG. 6 is a schematic diagram illustrating the hardware structure of an electronic device according to an embodiment of the present disclosure.

### DETAILED DESCRIPTION

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are a part of the embodiments of the present disclosure, not all of them. Based on the embodiments of the present disclosure, all other embodiments obtained by those skilled in the art without creative efforts fall within the scope of protection of the present disclosure.

Inventors of the present application find that public cloud providers generally realize the basic isolation and performance assurance through binding of vcpu (virtual machine process) and physical cores. However, when tenant services are high-load services, this may still cause underclocking of single-socket (CPU socket) or whole machine of the host, thereby degrading the service performances of other tenants in the same socket or the same host and also affecting tenant services (e.g., the latency of real-time tasks is increased, the performance in computing services falls short of expectations).

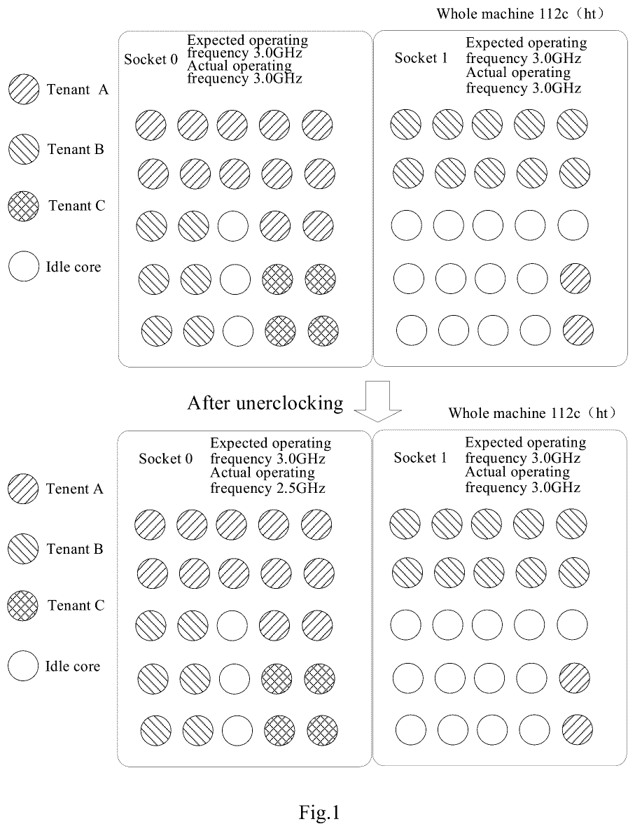

Specifically, the reason for the above fact is that different tenant virtual machines coexist in one physical socket or numa (Non-Uniform Memory Access, and in some cases, nume is an equivalent of socket) and in essence share power supply on the physical socket to run high-load services in the presence of a certain number of cores. For example, under rendering, AVX/AMX heavy-load commands, a single CPU (socket) will have a temperature rise after operating for a certain period of time and therefore will reach TDP (Thermal Design Power, which is related to specific CPU models) preset by CPU vendors and trigger hardware to perform underclocking. As illustrated in FIG. 1 in which use of cores by tenant A, B, and C in socket0 and socket1 is illustrated, when tenant A runs AMX heavy-load commands, socket0 reaches the TDP, resulting in underclocking of the entire CPU unit (including various cores) to which socket0 corresponds; the services of tenants B and C are also affected by this underclocking and an increase in latency may occur, as a result of which it is possible for tenants B and C to complain about the oversubscription or instability issue of the public cloud provider, and as for tenant A, performances may still fall short of expectations.

Therefore, when public cloud providers sell non-oversubscribed virtual machines in the public cloud, how to ensure the isolation between tenants has always been an important manifestation of the key competitiveness of major public cloud providers. In addition, CPU underclocking is common and unavoidable in the industry, so how to control the impact on tenant services caused by underclocking and ensure SLA (Service Level Agreement) is an urgent problem to be resolved.

To address the above-mentioned technical problem, provided in the embodiments of the present disclosure is a method for identifying underclocking risks in a public cloud, which includes: collecting frequency fluctuations of CPU units in a host in a public cloud environment; collecting CPU utilization rates of tenant virtual machines in the host; and sifting out risky virtual machines from the tenant virtual machines according to the frequency fluctuations of the CPU units and the CPU utilization rates of the tenant virtual machines. By detecting the frequency fluctuations of the CPU units and the CPU utilization rates of the tenant virtual machines in the host in the public cloud environment, risky virtual machines that may be affected by CPU underclocking can be sifted out in a rapid and accurate way and thus, a basis for migration and scheduling of the risky virtual machines can be provided, the impact caused by underclocking can be reduced, and load interference between various tenants in the public cloud can be avoided, both the stability of the tenant virtual machines in the public cloud and Service Level Agreement (SLA) in the public cloud can be guaranteed, and a better suitability for more tenants with different load types can be realized.

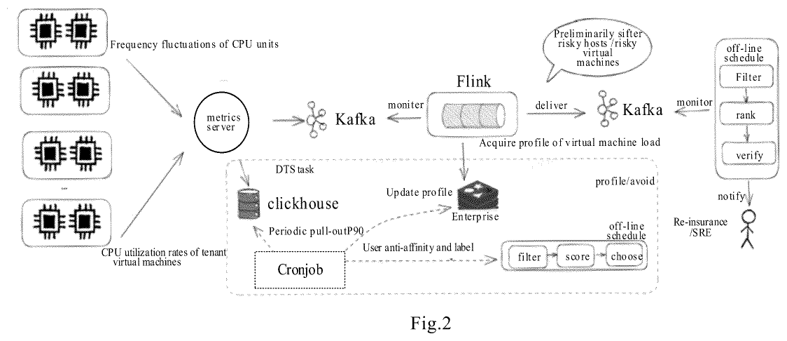

The system architecture of the method for identifying underclocking risks in a public cloud according to the embodiments of the present disclosure is illustrated in FIG. 2. Frequency fluctuations of CPU units in a host and CPU utilization rates of tenant virtual machines in the host can be collected into a metrics server, the CPU utilization rates of the tenant virtual machines are added downstream into a message queue (such as Kafka) through data tasks, the frequency fluctuations of the CPU units and the CPU utilization rates of the tenant virtual machines in the host are consumed in the message queue by a streaming data processing engine (such as Flink), and risky virtual machines are sifted out from the tenant virtual machines according to the frequency fluctuations of the CPU units and the CPU utilization rates of the tenant virtual machines and then stored in another message queue (such as Kafka) for subsequent refined sifting (i.e., offline scheduling).

Refined sifting (i.e., offline scheduling) is to: detect, according to a preset detection rule, whether the risky virtual machines are the target virtual machine being affected by underclocking, so as to sift out the target virtual machine being affected by underclocking; cause, during migration of the target virtual machines and by means of ranking, one or more target virtual machines which number of used cores of the target CPU unit is not 0 and which use the least number of cores of the target CPU unit, to migrate; judge whether the target virtual machine is allowed to migrate and validate the feasibility of migration before migration of the target virtual machine; and finally cause the target virtual machine to migrate so as to complete offline scheduling.

In addition, historical CPU usage rates of the tenant virtual machines can be acquired by an analytical database clickhouse, and based on the historical CPU usage rates, labels are added to various tenants (or, labels are added to the loads of various tenant virtual machines), with the labels including a high-load service type label and a low-load service type label; online scheduling is performed upon reception of a virtual machine creation request from any of the tenants, a host and/or a CPU unit for creating the tenant virtual machine is determined according to the label of this tenant, and the tenant virtual machine is created according to the virtual machine creation request. With a reasonable deployment of the tenant virtual machines in advance, the underclocking can be avoided as much as possible and the impact on tenant services caused by underclocking can be prevented.

It should be noted that all the information and data of users involved in the present application are information and data authorized by the users or fully authorized by all involved parties, and that collection, usage and processing of relevant data are required to comply with relevant laws, regulations and standards of relevant countries and regions, and that corresponding operation portals for the users to choose authorization or denial are offered.

The method for identifying underclocking risks in a public cloud according to the present disclosure will be described below in details in conjunction with specific embodiments.

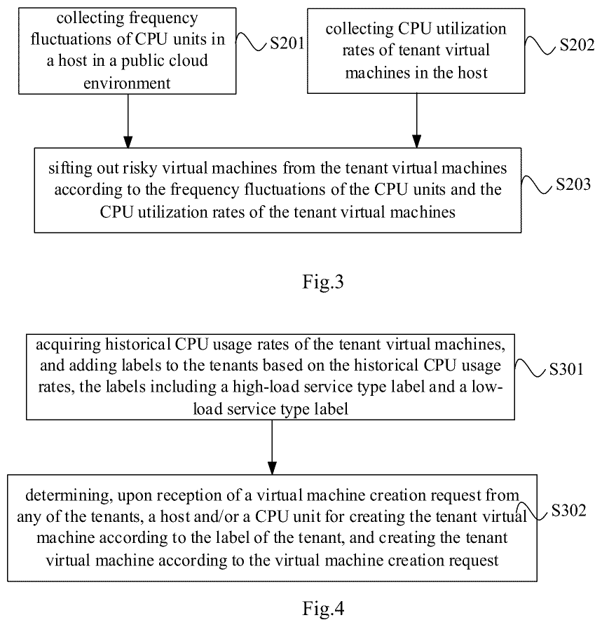

With reference to FIG. 3, FIG. 3 is a schematic flow diagram of the method for identifying underclocking risks in a public cloud according to an embodiment of the present disclosure. The method in this embodiment can be applied to a terminal device or a server. This method for identifying underclocking risks in a public cloud includes:

S201: collecting frequency fluctuations of CPU units in a host in a public cloud environment.

In this embodiment, the public cloud includes a plurality of hosts each of which typically includes two CPU units (i.e., a host typically includes two sockets or numas), and each CPU unit includes a plurality of cores (also referred to as kernels). Different tenant virtual machines may coexist in a same CPU unit and use different cores of this CPU unit. During CPU underclocking, underclocking of the entire CPU unit generally occurs. Thus, in this embodiment, the frequency fluctuations of the CPU units are detected on the dimension of the CPU units.

Optionally, for any CPU unit, frequency differences between actual operating frequencies and expected operating frequencies of each core of this CPU unit are acquired; and the frequency differences of each core of this CPU unit are aggregated to obtain the frequency fluctuation of this CPU unit. The formula can be as follows:

$$cpu\_x \_freq \_deviation = \frac{{\sum }_{0 < i < cores} ( {f}_{actual} ( {core}_{i} ) - {f}_{expect} ( {core}_{i} ) )}{{\sum }_{0 < i < cores} {f}_{expect} ( {core}_{i} )} * 1000$$

where cpu_x_freq_deviation denotes the frequency fluctuation of a CPU unit x, where x refers to the serial number of socket or numa, which is 0 or 1 in general; cores is the number of physical cores on a single socket or a single numa; f_{expect}(coreᵢ) is the expected operating frequency for cores, and may be an all turbo boost frequency in the white paper of the corresponding CPU vendor; f_{actual} (coreᵢ) is the actual operating frequency for cores, can be acquired from a register of CPU and is not the actual operating frequency acquired under a /proc or /sys interface of the core, so accuracy is improved; in this formula, multiplying by 1000 is to convert the frequency fluctuations into permillage so that the frequency fluctuations can be compared in a better way. Without doubt, it is also possible that such multiplying by 1000 is not executed. By way of example, it is assumed that cpu_0_freq_deviation=110, implying that the difference between the actual operating frequency and the expected operating frequency of the CPU on socket0 (110/1000) is equal to 11.1%, which is to say this CPU is underclocked by 11.1%.

S202: collecting CPU utilization rates of tenant virtual machines in the host.

In this embodiment, the CPU utilization rates of the tenant virtual machines in the host also need to be collected to give a reflection of the load condition of tenant services. It should be noted that the tenant virtual machines may use the cores of one single CPU unit, or the cores of different CPU units across the CPU units. The CPU utilization rates of the tenant virtual machines in this embodiment are the utilization rates of all the used cores and can be taken as a tenant virtual machine service profile to reflect the load condition of tenant services.

It should be noted that in terms of S201 and S202, their orders of execution are not distinguished.

S203: sifting out risky virtual machines from the tenant virtual machines according to the frequency fluctuations of the CPU units and the CPU utilization rates of the tenant virtual machines.

In this embodiment, after the frequency fluctuations of the CPU units and the CPU utilization rates of the tenant virtual machines in the host are acquired, it can be judged from the frequency fluctuations of the CPU units whether or not underclocking occurs in the CPUs, and upon occurrence of underclocking, it can be judged from the CPU utilization rates of the tenant virtual machines which tenant virtual machines may be affected by CPU underclocking, wherein the higher the CPU utilization rate is, the stronger the user's perception is during CPU underclocking and the more the tenant virtual machines are affected by CPU underclocking, whereas the lower the CPU utilization rate is, the weaker the user's perception is during underclocking and the less the tenant virtual machines are affected by CPU underclocking (e.g., even an underclocking by 20% may still be imperceptible to tenants with a normal load of 5% CPU utilization rate, and thus these tenants are less affected by CPU underclocking). As a result, risky virtual machines that may be affected by CPU underclocking can be sifted out from the tenant virtual machines, facilitating migration and scheduling of the tenant virtual machines and a reduction in the impact caused by CPU underclocking.

The method for identifying underclocking risks in a public cloud according to this embodiment includes collecting frequency fluctuations of CPU units in a host in a public cloud environment; collecting CPU utilization rates of tenant virtual machines in the host; and sifting out risky virtual machines from the tenant virtual machines according to the frequency fluctuations of the CPU units and the CPU utilization rates of the tenant virtual machines. By detecting the frequency fluctuations of the CPU units and the CPU utilization rates of the tenant virtual machines in the host in the public cloud environment, risky virtual machines that may be affected by CPU underclocking can be sifted out in a rapid and accurate way and thus, a basis for migration and scheduling of the risky virtual machines can be provided, the impact caused by underclocking can be reduced, and load interference between various tenants in the public cloud can be avoided, and the stability of the tenant virtual machines in the public cloud and Service Level Agreement (SLA) in the public cloud can both be guaranteed.

Based on the above embodiment, the sifting out risky virtual machines from the tenant virtual machines according to the frequency fluctuations of the CPU units and the CPU utilization rates of the tenant virtual machines in S203 may specifically include:
sifting out, from the tenant virtual machines, at least one tenant virtual machine with a CPU utilization rate larger than a preset CPU utilization rate threshold and determining the tenant virtual machine as the risky virtual machine, in response to the frequency fluctuation of underclocking of any target CPU unit exceeding a preset fluctuation threshold.

In this embodiment, if the frequency fluctuation of underclocking of any target CPU unit exceeds the preset fluctuation threshold (e.g., the preset fluctuation threshold is 10%), it can be determined that underclocking occurs in the CPU of the host and further the risky virtual machines that may be affected by CPU underclocking are sifted out on basis of the CPU utilization rates of the tenant virtual machines. A preset CPU utilization rate threshold can be set, for example, the preset CPU utilization rate threshold is 70%. If the CPU utilization rate of any tenant virtual machine in the host is larger than the preset CPU utilization rate threshold, then this tenant virtual machine is taken as the risky virtual machine.

The preset CPU utilization rate threshold can be set in accordance with requirements. In this embodiment, the reason why a 70% preset CPU utilization rate threshold is utilized is because the preset CPU utilization rate threshold is not set too high (such as 90%), leaving a certain margin for prevention of incomplete sifting. Furthermore, this 70% CPU utilization rate belongs to high-load services, and tenants with high-load services pay much more attention to CPU utilization rate.

In another optional embodiment, fluctuations of the CPU utilization rates of the tenant virtual machines may also be detected. If it is determined that the frequency fluctuation of underclocking of any target CPU unit exceeds the preset fluctuation threshold, then tenant virtual machines in which the fluctuations of the CPU utilization rates exceed the preset CPU utilization rate fluctuation threshold (such as 10%) are sifted out from the tenant virtual machines and underclocking of the target CPU unit is considered to lead to a decrease in the CPU utilization rates of the tenant virtual machines, so these tenant virtual machines are determined as the risky virtual machines. However, the computing complexity in this embodiment is relatively high, which affects the timeliness in identifying the risky virtual machines.

Based on the above embodiment, after the risky virtual machine is sifted out, a further refined sifting (i.e., secondary decision) may also be performed that detects, according to a preset detection rule, whether the risky virtual machines are truly target virtual machine being affected by underclocking.

In this embodiment, based on the frequency fluctuations of the CPU unit and the CPU utilization rates of the tenant virtual machines in the host, it is only possible to preliminarily determine which tenant virtual machines may be affected by CPU underclocking, that is the risk of being affected. With the refined sifting, however, target virtual machines that are truly affected by underclocking can be determined. Since only the CPU utilization rate is considered for the risky virtual machines, more information of the tenant virtual machines can be considered in refined sifting, including but not limited to: whether or not the tenant belongs to a preset tenant set (a tenant whitelist), whether or not the host is exclusive to the tenant, distribution of the cores used by the tenant, and so on. The target virtual machines that are truly affected can be precisely sifted out by configuring the preset detection rule in combination with one or more of the above pieces of information.

Optionally, detecting whether the risky virtual machine is a target virtual machine being affected by underclocking according to a preset detection rule may specifically include:
judging whether a tenant corresponding to the risky virtual machine belongs to a preset tenant set, and if the tenant corresponding to the risky virtual machine belongs to the preset tenant set, determining that the risky virtual machine is not the target virtual machine being affected by underclocking; and/or
judging whether the host is exclusive to the risky virtual machine, and if the host is exclusive to the risky virtual machine, then determining that the risky virtual machine is not the target virtual machine being affected by underclocking; and/or
detecting whether the risky virtual machine is the target virtual machine being affected by underclocking according to a number of cores of the target CPU unit used by the risky virtual machine.

In this embodiment, the preset tenant set includes a plurality of preset tenants. These tenants pay no attention to CPU underclocking or consider that they will not be affected even in case of CPU underclocking, or there is no need of scheduling and migration for these tenant virtual machines. If the tenant corresponding to the risky virtual machine belongs to the preset tenant set, then it is determined that this risky virtual machine is not the target virtual machine being affected by underclocking, and this risky virtual machine can be excluded.

In addition, if the host is exclusive to a risky virtual machine, namely only this risky virtual machine exists in the host without the presence of other tenant virtual machines, then CPU underclocking is caused by this risky virtual machine itself, which is expectable. Thus, it is also determined that this risky virtual machine is not the target virtual machine being affected by underclocking, and this risky virtual machine can be excluded.

In addition, since underclocking occurs in the target CPU unit and the extent to which a risky virtual machine is affected also depends on the number of cores of the target CPU unit used by this risky virtual machine, it can be determined, according to the number of cores of the target CPU unit used by the risky virtual machine, whether this risky virtual machine is the target virtual machine being affected by underclocking.

Optionally, if the number of cores of the target CPU unit used by the risky virtual machine is 0, namely this risky virtual machine does not use the cores of the target CPU unit and is therefore not affected by underclocking of the target CPU unit, then it can be determined that this risky virtual machine is not the target virtual machine being affected by underclocking, and this risky virtual machine can be excluded.

Optionally, if the number of cores of the target CPU unit used by the risky virtual machine is not 0 and smaller than a preset number-of-core threshold, it means that the risky virtual machine uses a smaller number of cores of the target CPU unit and is more likely to be affected by underclocking of the target CPU unit, and that it is more convenient for the services on the cores used in the target CPU unit by the risky virtual machine to migrate. Therefore, this risky virtual machine is determined as the target virtual machine being affected by underclocking and subsequent migration may proceed, and the services on the cores used in the target CPU unit by the risky virtual machine is caused to migrate into other CPU units.

Optionally, the risky virtual machine which number of used cores of the target CPU unit is not 0 are ranked according to the number of used cores of the target CPU unit, and one or more risky virtual machines which use the least number of cores of the target CPU unit in the ranking are determined as the target virtual machine being affected by underclocking.

In this embodiment, the risky virtual machine which number of cores of the target CPU unit is not 0 are ranked according to the number of used cores of the target CPU unit, one or more risky virtual machines which use the least number of cores of the target CPU unit in the ranking are more likely to be affected by underclocking of the target CPU unit and also become more convenient for migration. Therefore, one or more risky virtual machines which use the least number of cores of the target CPU unit are determined as the target virtual machine being affected by underclocking and subsequent migration may proceed, and the services on the cores used in the target CPU unit by the risky virtual machine are caused to migrate into other CPU units.

The risky virtual machine which uses a larger number of cores of the target CPU unit in the ranking may be virtual machine that leads to underclocking of the target CPU unit or may be difficult to migrate due to the large number of cores involved. As a result, these risky virtual machines are excluded.

Based on the above embodiment, after the risky virtual machine is determined as the target virtual machine being affected by underclocking, the target virtual machines may also be caused to migrate, and in particular the service on the cores used in the target CPU unit by the risky virtual machine is caused to migrate into other CPU units. That is to say, the target virtual machine no longer uses the cores of the target CPU unit and thus will not be affected by underclocking of the target CPU unit.

Optionally, during migration of the target virtual machine, instead of causing all the target virtual machines to migrate, one or more target virtual machines which number of used cores of the target CPU unit is not 0 and which use the least number of cores of the target CPU unit are caused to migrate (the service on the cores used in the target CPU unit by these target virtual machines is caused to migrate into other CPU units), avoiding an excessive migration bandwidth.

Based on any of the above embodiments, it may also be judged prior to migration of the target virtual machine whether the target virtual machine is allowed to migrate; and if it is determined that the target virtual machine is allowed to migrate, then the target virtual machine is caused to migrate; otherwise, if the target virtual machine is not allowed to migrate, then migration of the target virtual machines does not occur.

Optionally, multiple factors may be taken into account when it is judged whether the target virtual machine is allowed to migrate. For example, it is judged whether a migration-allowed label (or a migration-not-allowed label) is preset for the target virtual machine, and according to the label, it can be determined whether the target virtual machine is allowed to migrate. In addition, a protection grade is also preset for the target virtual machine, wherein some protection grades allow migration while some protection grades do not allow migration, and it can be judged whether the protection grade for the target virtual machines are a migration-allowed protection grade, so as to determine whether the target virtual machine is allowed to migrate. Without doubt, other factors may also be taken into account when it is judged whether migration is allowed, and no limitation thereto is given here.

On this basis, it is determined that the target virtual machine is allowed to migrate, if the migration-allowed label is preset for the target virtual machine and/or a protection grade for the target virtual machine satisfies a migration-allowed protection grade.

Optionally, after the target virtual machine is sifted out, a risk notification may also be provided to notify the tenant that the target virtual machine is affected by underclocking. Also, a request about whether migration occurs may be sent to the tenant, and the target virtual machine is caused to migrate after the tenant is determined to migrate.

Specifically, based on any of the above embodiments, the collecting the frequency fluctuations of the CPU units in the host in the public cloud environment in S201 may include:
collecting the frequency fluctuations of the CPU units in the host at intervals of a first preset time and adding the frequency fluctuations to a message queue, consuming the frequency fluctuations of the CPU units in the message queue through a streaming data processing engine, and filtering the frequency fluctuations of the same CPU unit to filter out abnormal frequency fluctuations.

In this embodiment, the frequency fluctuations of the CPU units in the host can be collected into a metrics server at intervals of the first preset time, the frequency fluctuations of the CPU units are added downstream into a message queue (such as Kafka) through data tasks, the frequency fluctuations of the CPU units are consumed in the message queue by a streaming data processing engine (such as Flink), and the frequency fluctuations of the same CPU unit are filtered to filter out abnormal frequency fluctuations, such as some abnormal frequency fluctuations with severe deviations.

When being collected, the CPU utilization rates of the tenant virtual machines in the host may also be collected into the metrics server at intervals of a preset time, the CPU utilization rates of the tenant virtual machines are added downstream into the message queue (such as Kafka) through data tasks, and then the CPU utilization rates of the tenant virtual machines are consumed in the message queue by the streaming data processing engine (such as Flink).

The risky virtual machines are sifted out from the tenant virtual machines according to the frequency fluctuations of the CPU units and the CPU utilization rates of the tenant virtual machines, and then stored in another message queue (such as Kafka) for subsequent refined sifting. The subsequent refined sifting process may consume the risky virtual machines in the message queue for refined sifting, which specifically may include but not limited to filtering, ranking, validation for whether or not migration is allowed, or the like.

Based on any of the above embodiments, the method, as illustrated in FIG. 4, further includes:

S301: acquiring historical CPU usage rates of the tenant virtual machines, and adding labels to the tenants based on the historical CPU usage rates, the labels including a high-load service type label and a low-load service type label;

S302: determining, upon reception of a virtual machine creation request from any of the tenants, a host and/or a CPU unit for creating the tenant virtual machine according to the label of the tenant and creating the tenant virtual machine according to the virtual machine creation request.

In this embodiment, the historical CPU usage rates of the tenant virtual machines in the host can be acquired, service profiles corresponding to the tenants are attained according to the historical CPU usage rates, namely it is judged whether the service load of the tenant is high or low, and thus labels can be added to the tenants, wherein the labels include a high-load service type label and a low-load service type label. When any of these tenants creates a new virtual machine, i.e., when the virtual machine creation request for the tenant is received, an appropriate host and/or CPU unit can be chosen according to the label of the tenant, to create the new virtual machine for the tenant, wherein combined with an online scheduling anti-affinity capability, the virtual machines of the tenants with the high-load service type label are isolated on different hosts as much as possible, and with a reasonable deployment of the tenant virtual machines in advance, the underclocking is avoided as much as possible and the impact on tenant services caused by underclocking can be prevented.

The acquiring historical CPU usage rates of the tenant virtual machines includes:
collecting the CPU utilization rates of the tenant virtual machines at intervals of a second preset time, and storing the CPU utilization rates in an analytical database; and
determining CPU utilization rates to which preset quantiles of the CPU utilization rates of the same tenant virtual machine at different time are corresponding by using the analytical database, to determine as the historical CPU usage rates of the tenant virtual machine.

In this embodiment, the CPU utilization rates of the tenant virtual machines are collected at intervals of the second preset time, and analyzed using the analytical database, wherein the analytical database may be an OLAP data clickhouse or any other analytical database. By analyzing the CPU utilization rates of the same tenant virtual machine at different historical time (time series data), the CPU utilization rates to which preset quantiles of the CPU utilization rates are corresponding are found, e.g., P99 (99% quantile) or P90 (90% quantile) and are determined as the historical CPU usage rates of the tenant virtual machine. When the historical CPU usage rates of the tenant virtual machine exceed a preset threshold, the tenant is determined as a high-load service type and the high-load service type label is added to the tenant through a label-adding service.

Corresponding to the method for identifying underclocking risks in a public cloud according to the above-mentioned embodiment, FIG. 5 is a block diagram illustrating the structure of a device for identifying underclocking risks in a public cloud according to an embodiment of the present disclosure. For the sake of brevity, only the parts related to the embodiments of the present disclosure are illustrated. With reference to FIG. 5, the device for identifying underclocking risks in a public cloud 500 includes: a CPU frequency fluctuation collecting unit 501, a CPU utilization rate collecting unit 502, and an identifying unit 503.

Among these units, the CPU frequency fluctuation collecting unit 501 is configured to collect frequency fluctuations of CPU units in a host in a public cloud environment; wherein each CPU unit includes a plurality of cores;
the CPU utilization rate collecting unit 502 is configured to collect CPU utilization rates of tenant virtual machines in the host; and
the identifying unit 503 is configured to sift out risky virtual machines from the tenant virtual machines according to the frequency fluctuations of the CPU units and the CPU utilization rates of the tenant virtual machines.

In one or more embodiments of the present disclosure, the identifying unit 503, when sifting out risky virtual machines from the tenant virtual machines according to the frequency fluctuations of the CPU units and the CPU utilization rates of the tenant virtual machines, is configured to:
sift out, from the tenant virtual machines, at least one tenant virtual machine with a CPU utilization rate larger than a preset CPU utilization rate threshold to determine as the risky virtual machine, in response to the frequency fluctuation of underclocking of any target CPU unit exceeding a preset fluctuation threshold.

In one or more embodiments of the present disclosure, the identifying unit 503, after the risky virtual machine is sifted out, is also configured to:
detect whether the risky virtual machine is a target virtual machine being affected by underclocking according to a preset detection rule.

In one or more embodiments of the present disclosure, the identifying unit 503, when detecting whether the risky virtual machine is a target virtual machine being affected by underclocking according to a preset detection rule, is configured to:
judge whether a tenant corresponding to the risky virtual machines belongs to a preset tenant set, and if the tenants corresponding to the risky virtual machine belongs to the preset tenant set, determine that the risky virtual machine is not the target virtual machine being affected by underclocking; and/or
judge whether the host is exclusive to the risky virtual machines, and if the host is exclusive to the risky virtual machine, determine that the risky virtual machine is not the target virtual machine being affected by underclocking; and/or
detect whether the risky virtual machine is the target virtual machine being affected by underclocking according to a number of cores of the target CPU unit used by the risky virtual machine.

In one or more embodiments of the present disclosure, the identifying unit 503, when detecting whether the risky virtual machine is the target virtual machine being affected by underclocking according to a number of cores of the target CPU unit used by the risky virtual machines, is configured to:
determine that the risky virtual machine is the target virtual machine being affected by underclocking, if the number of cores of the target CPU unit used by the risky virtual machines is not 0 and smaller than a preset number-of-core threshold; or
rank, according to the number of used cores of the target CPU unit, the risky virtual machines which number of used cores of the target CPU unit is not 0, and determine, in the ranking, one or more risky virtual machines which use the least number of cores of the target CPU unit, as the target virtual machine being affected by underclocking; or
determine that the risky virtual machine is not the target virtual machine being affected by underclocking, if the number of cores of the target CPU unit used by the risky virtual machine is 0.

In one or more embodiments of the present disclosure, the device further includes a scheduling unit 504, configured to cause the target virtual machines to migrate after it is determined that the risky virtual machine is the target virtual machine being affected by underclocking.

In one or more embodiments of the present disclosure, the scheduling unit 504, when causing the target virtual machines to migrate, is configured to:
cause one or more target virtual machines which number of used cores of the target CPU unit is not 0 and which use the least number of cores of the target CPU unit, to migrate.

In one or more embodiments of the present disclosure, the scheduling unit 504, when causing the target virtual machines to migrate, is configured to:
judge whether the target virtual machine is allowed to migrate; and
cause the target virtual machines to migrate if it is determined that the target virtual machine is allowed to migrate.

In one or more embodiments of the present disclosure, the scheduling unit 504, when judging whether the target virtual machines is allowed to migrate, is configured to:
determine that the target virtual machine is allowed to migrate, if a migration-allowed label is preset for the target virtual machines and/or a protection grade for the target virtual machines satisfies a migration-allowed protection grade.

In one or more embodiments of the present disclosure, the CPU utilization rate collecting unit 502, when collecting frequency fluctuations of CPU units in a host in a public cloud environment, is configured to:
collect the frequency fluctuations of the CPU units in the host at intervals of a first preset time and add the frequency fluctuations to a message queue, consume the frequency fluctuations of the CPU units in the message queue through a streaming data processing engine, and filter the frequency fluctuations of the same CPU unit to filter out abnormal frequency fluctuations.

In one or more embodiments of the present disclosure, the CPU frequency fluctuation collecting unit 501, when collecting frequency fluctuations of CPU units in a host in a public cloud environment, is configured to:
acquire, for any CPU unit, frequency differences between actual operating frequencies and expected operating frequencies of each core of the CPU unit; and
aggregate the frequency differences of each core of the CPU unit to obtain the frequency fluctuation of the CPU unit.

In one or more embodiments of the present disclosure, the CPU frequency fluctuation collecting unit 501 is also configured to acquire historical CPU usage rates of the tenant virtual machines.

The scheduling unit 504 is also configured to: add labels to the tenants based on the historical CPU usage rates, the labels including a high-load service type label and a low-load service type label; and determine, upon reception of a virtual machine creation request from any of the tenants, a host and/or a CPU unit for creating the tenant virtual machine according to the label of the tenant, and create the tenant virtual machine according to the virtual machine creation request.

In one or more embodiments of the present disclosure, the CPU frequency fluctuation collecting unit 501, when acquiring historical CPU usage rates of the tenant virtual machines, is configured to:
collect the CPU utilization rates of the tenant virtual machines at intervals of a second preset time, and store the CPU utilization rates in an analytical database; and
determine CPU utilization rates to which preset quantiles of the CPU utilization rates of the same tenant virtual machine at different time are corresponding by using the analytical database to determine as the historical CPU usage rates of the tenant virtual machine.

The device according to this embodiment can be applied to execute the technical solution of the above-mentioned method embodiment, and since its implementation principle and technical effects are similar, a description thereof is not repeated in this embodiment.

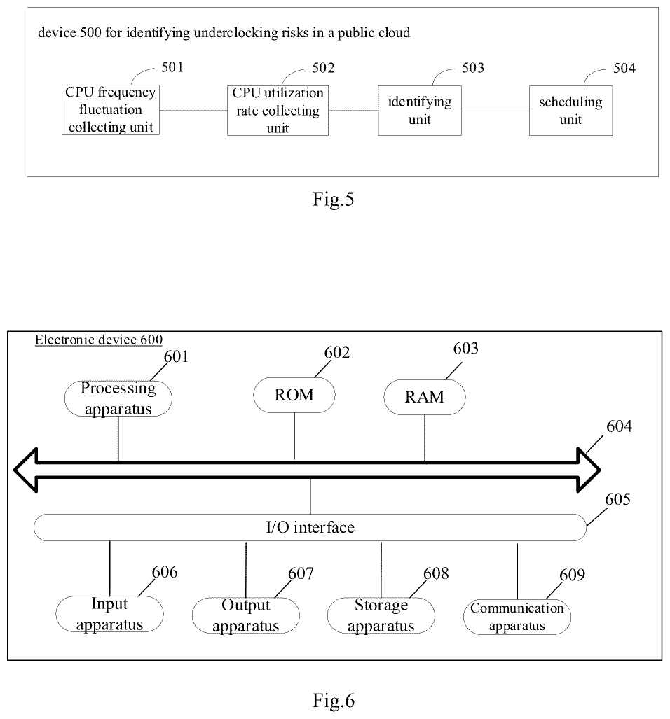

With reference to FIG. 6, FIG. 6 illustrates a schematic structural diagram of an electronic device 600 suitable for implementing some embodiments of the present disclosure. The electronic device 600 can be a terminal device or server. The terminal device may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), the like, and fixed terminals such as a digital TV, a desktop computer, or the like. The electronic device illustrated in FIG. 6 is merely an example and should not pose any limitation to the functions and the range of use of the embodiments of the present disclosure.

As illustrated in FIG. 6, the electronic device 600 may include a processing apparatus 601 (e.g., a central processing unit, a graphics processing unit, etc.), which can perform various suitable actions and processing according to a program stored in a read-only memory (referred as ROM) 602 or a program loaded from a storage apparatus 608 into a random-access memory (referred as RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 6 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device or may also exist alone without being assembled into the electronic device.

The above-mentioned computer-readable medium carries one or more programs, and when the one or more programs are executed by the electronic device, the electronic device is caused to implement the methods of the above embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (referred as LAN) or a wide area network (referred as WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit also can be described a “unit for acquiring at least two internet protocol addresses.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a method for identifying underclocking risks in a public cloud is provided, and the method includes:
collecting frequency fluctuations of CPU units in a host in a public cloud environment; wherein each of the CPU units includes a plurality of cores;
collecting CPU utilization rates of tenant virtual machines in the host; and
sifting out risky virtual machines from the tenant virtual machines according to the frequency fluctuations of the CPU units and the CPU utilization rates of the tenant virtual machines.

According to one or more embodiments of the present disclosure, the sifting out risky virtual machines from the tenant virtual machines according to the frequency fluctuations of the CPU units and the CPU utilization rates of the tenant virtual machines includes:
sifting out, from the tenant virtual machines, at least one tenant virtual machine with a CPU utilization rate larger than a preset CPU utilization rate threshold, to determine as the risky virtual machine, in response to the frequency fluctuation of underclocking of any target CPU unit exceeding a preset fluctuation threshold.

According to one or more embodiments of the present disclosure, the method, after the risky virtual machine is sifted out, further includes:
detecting whether the risky virtual machine is a target virtual machine being affected by underclocking according to a preset detection rule.

According to one or more embodiments of the present disclosure, the detecting whether the risky virtual machine is a target virtual machine being affected by underclocking according to a preset detection rule includes:
judging whether a tenant corresponding to the risky virtual machine belongs to a preset tenant set, and if the tenant corresponding to the risky virtual machine belongs to the preset tenant set, determining that the risky virtual machine is not the target virtual machine being affected by underclocking; and/or
judging whether the host is exclusive to the risky virtual machine, and if the host is exclusive to the risky virtual machine, then determining that the risky virtual machine is not the target virtual machine being affected by underclocking; and/or
detecting whether the risky virtual machine is the target virtual machine being affected by underclocking according to a number of cores of the target CPU unit used by the risky virtual machine.

According to one or more embodiments of the present disclosure, the detecting whether the risky virtual machine is the target virtual machine being affected by underclocking according to a number of cores of the target CPU unit used by the risky virtual machine includes:
determining that the risky virtual machine is the target virtual machine being affected by underclocking, if the number of cores of the target CPU unit used by the risky virtual machine is not 0 and smaller than a preset number-of-core threshold; or
ranking, according to the number of used cores of the target CPU unit, the risky virtual machine which number of used cores of the target CPU unit is not 0, and determining, in the ranking, one or more risky virtual machines which use the least number of cores of the target CPU unit, as the target virtual machine being affected by underclocking; or
determining that the risky virtual machine is not the target virtual machine being affected by underclocking, if the number of cores of the target CPU unit used by the risky virtual machines is 0.

According to one or more embodiments of the present disclosure, the method, after determining that the risky virtual machine is the target virtual machine being affected by underclocking, further includes:
causing the target virtual machine to migrate.

According to one or more embodiments of the present disclosure, the causing the target virtual machine to migrate includes:
causing one or more target virtual machines which number of used cores of the target CPU unit is not 0 and which use the least number of cores of the target CPU unit, to migrate.

According to one or more embodiments of the present disclosure, the causing the target virtual machine to migrate includes:
judging whether the target virtual machine is allowed to migrate; and
causing the target virtual machine to migrate if it is determined that the target virtual machine is allowed to migrate.

According to one or more embodiments of the present disclosure, the judging whether the target virtual machines is allowed to migrate includes:
determining that the target virtual machine is allowed to migrate, if a migration-allowed label is preset for the target virtual machine and/or a protection grade for the target virtual machine satisfies a migration-allowed protection grade.

According to one or more embodiments of the present disclosure, the collecting frequency fluctuations of CPU units in a host in a public cloud environment includes:
collecting the frequency fluctuations of the CPU units in the host at intervals of a first preset time and adding the frequency fluctuations to a message queue, consuming the frequency fluctuations of the CPU units in the message queue through a streaming data processing engine, and filtering the frequency fluctuations of the same CPU unit to filter out abnormal frequency fluctuations.

According to one or more embodiments of the present disclosure, the collecting frequency fluctuations of CPU units in a host in a public cloud environment includes:
acquiring, for any of the CPU units, frequency differences between actual operating frequencies and expected operating frequencies of each core of the CPU unit; and
aggregating the frequency differences of each core of the CPU unit to obtain the frequency fluctuation of the CPU unit.

According to one or more embodiments of the present disclosure, the method further includes:
acquiring historical CPU usage rates of the tenant virtual machines, and adding labels to the tenants based on the historical CPU usage rates, the labels including a high-load service type label and a low-load service type label; and
determining, upon reception of a virtual machine creation request from any of the tenants, a host and/or a CPU unit for creating the tenant virtual machine according to the label of the tenant and creating the tenant virtual machine according to the virtual machine creation request.

According to one or more embodiments of the present disclosure, the acquiring historical CPU usage rates of the tenant virtual machines includes:
collecting the CPU utilization rates of the tenant virtual machines at intervals of a second preset time, and storing the CPU utilization rates in an analytical database; and
determining CPU utilization rates to which preset quantiles of the CPU utilization rates of the same tenant virtual machine at different time are corresponding by using the analytical database to determine as the historical CPU usage rates of the tenant virtual machine.

According to one or more embodiments of the present disclosure, a device for identifying underclocking risks in a public cloud is provided, and the device includes:
a CPU frequency fluctuation collecting unit, configured to collect frequency fluctuations of CPU units in a host in a public cloud environment; wherein each CPU unit includes a plurality of cores;
a CPU utilization rate collecting unit, configured to collect CPU utilization rates of tenant virtual machines in the host; and
an identifying unit, configured to sift out risky virtual machines from the tenant virtual machines according to the frequency fluctuations of the CPU units and the CPU utilization rates of the tenant virtual machines.

According to one or more embodiments of the present disclosure, the identifying unit, when sifting out risky virtual machines from the tenant virtual machines according to the frequency fluctuations of the CPU units and the CPU utilization rates of the tenant virtual machines, is configured to:
sift out, from the tenant virtual machines, at least one tenant virtual machine with a CPU utilization rate larger than a preset CPU utilization rate threshold to determine as the risky virtual machine, in response to the frequency fluctuation of underclocking of any target CPU unit exceeding a preset fluctuation threshold.

According to one or more embodiments of the present disclosure, the identifying unit, after the risky virtual machine is sifted out, is also configured to:
detect whether the risky virtual machine is the target virtual machine being affected by underclocking according to a preset detection rule.

According to one or more embodiments of the present disclosure, the identifying unit, when detecting whether the risky virtual machine is the target virtual machine being affected by underclocking according to a preset detection rule, is configured to:
judge whether a tenant corresponding to the risky virtual machine belongs to a preset tenant set, and if the tenant corresponding to the risky virtual machine belongs to the preset tenant set, determine that the risky virtual machine is not the target virtual machine being affected by underclocking; and/or
judge whether the host is exclusive to the risky virtual machines, and if the host is exclusive to the risky virtual machine, determine that the risky virtual machine is not the target virtual machine being affected by underclocking; and/or
detect whether the risky virtual machine is the target virtual machine being affected by underclocking according to a number of cores of the target CPU unit used by the risky virtual machine.

According to one or more embodiments of the present disclosure, the identifying unit, when detecting whether the risky virtual machine is the target virtual machine being affected by underclocking according to a number of cores of the target CPU unit used by the risky virtual machine, is configured to:
determine that the risky virtual machine is the target virtual machine being affected by underclocking, if the number of cores of the target CPU unit used by the risky virtual machine is not 0 and smaller than a preset number-of-core threshold; or
rank, according to the number of used cores of the target CPU unit, the risky virtual machine which number of used cores of the target CPU unit is not 0, and determine, in the ranking, one or more risky virtual machines which use the least number of cores of the target CPU unit, as the target virtual machine being affected by underclocking; or
determine that the risky virtual machine is not the target virtual machine being affected by underclocking, if the number of cores of the target CPU unit used by the risky virtual machine is 0.

According to one or more embodiments of the present disclosure, the device further includes a scheduling unit, configured to cause the target virtual machines to migrate after it is determined that the risky virtual machine is the target virtual machine being affected by underclocking.

According to one or more embodiments of the present disclosure, the scheduling unit, when causing the target virtual machine to migrate, is configured to:
cause one or more target virtual machines which number of used cores of the target CPU unit is not 0 and which use the least number of cores of the target CPU unit, to migrate.

According to one or more embodiments of the present disclosure, the scheduling unit, when causing the target virtual machine to migrate, is configured to:
judge whether the target virtual machine is allowed to migrate; and
cause the target virtual machine to migrate if it is determined that the target virtual machine is allowed to migrate.

According to one or more embodiments of the present disclosure, the scheduling unit, when judging whether the target virtual machine is allowed to migrate, is configured to:
determine that the target virtual machine is allowed to migrate, if a migration-allowed label is preset for the target virtual machine and/or a protection grade for the target virtual machine satisfies a migration-allowed protection grade.

According to one or more embodiments of the present disclosure, the CPU utilization rate collecting unit, when collecting frequency fluctuations of CPU units in a host in a public cloud environment, is configured to:
collect the frequency fluctuations of the CPU units in the host at intervals of a first preset time and add the frequency fluctuations to a message queue, consume the frequency fluctuations of the CPU units in the message queue through a streaming data processing engine, and filter the frequency fluctuations of the same CPU unit to filter out abnormal frequency fluctuations.

According to one or more embodiments of the present disclosure, the CPU frequency fluctuation collecting unit, when collecting frequency fluctuations of CPU units in a host in a public cloud environment, is configured to:
acquire, for any CPU unit, frequency differences between actual operating frequencies and expected operating frequencies of each core of the CPU unit; and
aggregate the frequency differences of each core of the CPU unit to obtain the frequency fluctuation of the CPU unit.

According to one or more embodiments of the present disclosure, the CPU frequency fluctuation collecting unit is also configured to acquire historical CPU usage rates of the tenant virtual machines.

The scheduling unit is also configured to: add labels to the tenants based on the historical CPU usage rates, the labels including a high-load service type label and a low-load service type label; and determine, upon reception of a virtual machine creation request from any of the tenants, a host and/or a CPU unit for creating the tenant virtual machine according to the label of the tenant, and create the tenant virtual machine according to the virtual machine creation request.

According to one or more embodiments of the present disclosure, the CPU frequency fluctuation collecting unit, when acquiring historical CPU usage rates of the tenant virtual machines, is configured to:
collect the CPU utilization rates of the tenant virtual machines at intervals of a second preset time, and store the CPU utilization rates in an analytical database; and
determine CPU utilization rates to which preset quantiles of the CPU utilization rates of the same tenant virtual machine at different time are corresponding by using the analytical database to determine as the historical CPU usage rates of the tenant virtual machine.

According to one or more embodiments of the present disclosure, an electronic device is provided. The electronic device includes at least one processor and at least one memory;
the at least one memory is stored with computer executable instructions;
the at least one processor executes the computer executable instructions stored in the at least one memory, such that the at least one processor executes the method for identifying underclocking risks in a public cloud as described in the above and various possible designs of the above.

According to one or more embodiments of the present disclosure, a non-transient computer readable storage medium is provided. The computer executable instructions are stored in the computer readable storage medium, and the processor, when executing the computer executable instructions, implements the method for identifying underclocking risks in a public cloud as described in the above and various possible designs of the above.

According to one or more embodiments of the present disclosure a computer program product is provided that includes computer executable instructions. A processor, when executing the computer executable instructions, implements the method for identifying underclocking risks in a public cloud as described in the above and various possible designs of the above.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for identifying underclocking risks in a public cloud, comprising:
collecting frequency fluctuations of CPU units in a host in a public cloud environment, wherein each of the CPU units comprises a plurality of cores;
collecting CPU utilization rates of tenant virtual machines in the host; and
sifting out risky virtual machines from the tenant virtual machines according to the frequency fluctuations of the CPU units and the CPU utilization rates of the tenant virtual machines.

2. The method according to claim 1, wherein the sifting out risky virtual machines from the tenant virtual machines according to the frequency fluctuations of the CPU units and the CPU utilization rates of the tenant virtual machines comprises:
sifting out, from the tenant virtual machines, at least one tenant virtual machine with a CPU utilization rate larger than a preset CPU utilization rate threshold, to determine as the risky virtual machine, in response to the frequency fluctuation of underclocking of any target CPU unit exceeding a preset fluctuation threshold.

3. The method according to claim 1, wherein the method, after the risky virtual machine is sifted out, further comprises:
detecting whether the risky virtual machine is a target virtual machine being affected by underclocking according to a preset detection rule.

4. The method according to claim 3, wherein the detecting whether the risky virtual machine is a target virtual machine being affected by underclock according to a preset detection rule comprises:
judging whether a tenant corresponding to the risky virtual machines belongs to a preset tenant set, and if the tenant corresponding to the risky virtual machines belongs to the preset tenant set, determining that the risky virtual machine is not the target virtual machine being affected by underclocking; and/or
judging whether the host is exclusive to the risky virtual machines, and if the host is exclusive to the risky virtual machines, then determining that the risky virtual machine is not the target virtual machine being affected by underclocking; and/or
detecting whether the risky virtual machine is the target virtual machine being affected by underclocking according to a number of cores of the target CPU unit used by the risky virtual machine.

5. The method according to claim 4, wherein the detecting whether the risky virtual machine is the target virtual machine being affected by underclocking according to a number of cores of the target CPU unit used by the risky virtual machine comprises:
determining that the risky virtual machine is the target virtual machine being affected by underclocking, if the number of cores of the target CPU unit used by the risky virtual machine is not 0 and smaller than a preset number-of-core threshold; or
ranking, according to the number of used cores of the target CPU unit, the risky virtual machine which number of used cores of the target CPU unit is not 0, and determining, in the ranking, one or more risky virtual machines which use the least number of cores of the target CPU unit, as the target virtual machine being affected by underclocking; or
determining that the risky virtual machine is not the target virtual machine being affected by underclocking, if the number of cores of the target CPU unit used by the risky virtual machines is 0.

6. The method according to claim 3, wherein the method, after determining that the risky virtual machine is the target virtual machine being affected by underclocking, further comprises:
causing the target virtual machine to migrate.

7. The method according to claim 6, wherein the causing the target virtual machines to migrate comprises:
causing one or more target virtual machines which number of used cores of the target CPU unit is not 0 and which use the least number of cores of the target CPU unit, to migrate.

8. The method according to claim 6, wherein the causing the target virtual machine to migrate comprises:
judging whether the target virtual machine is allowed to migrate; and
causing the target virtual machine to migrate if it is determined that the target virtual machine is allowed to migrate.

9. The method according to claim 8, wherein the judging whether the target virtual machine is allowed to migrate comprises:
determining that the target virtual machines are allowed to migrate, if a migration-allowed label is preset for the target virtual machines and/or a protection grade for the target virtual machine satisfies a migration-allowed protection grade.

10. The method according to claim 1, wherein the collecting frequency fluctuations of CPU units in a host in a public cloud environment comprises:
collecting the frequency fluctuations of the CPU units in the host at intervals of a first preset time and adding the frequency fluctuations to a message queue, consuming the frequency fluctuations of the CPU units in the message queue through a streaming data processing engine, and filtering the frequency fluctuations of the same CPU unit to filter out abnormal frequency fluctuations.

11. The method according to claim 1, wherein the collecting frequency fluctuations of CPU units in a host in a public cloud environment comprises:
acquiring, for any of the CPU units, frequency differences between actual operating frequencies and expected operating frequencies of each core of the CPU unit; and
aggregating the frequency differences of each core of the CPU unit to obtain the frequency fluctuation of the CPU unit.

12. The method according to claim 1, further comprising:
acquiring historical CPU usage rates of the tenant virtual machines, and adding labels to the tenants based on the historical CPU usage rates, the labels comprising a high-load service type label and a low-load service type label; and
determining, upon reception of a virtual machine creation request from any of the tenants, a host and/or a CPU unit for creating the tenant virtual machine according to the label of the tenant and creating the tenant virtual machine according to the virtual machine creation request.

13. The method according to claim 12, wherein the acquiring historical CPU usage rates of the tenant virtual machines comprises:
collecting the CPU utilization rates of the tenant virtual machines at intervals of a second preset time, and storing the CPU utilization rates in an analytical database; and
determining CPU utilization rates to which preset quantiles of the CPU utilization rates of the same tenant virtual machine at different times are corresponding by using the analytical database to determine as the historical CPU usage rates of the tenant virtual machine.

14. An electronic device, comprising: at least one processor and at least one memory;
wherein the at least one memory is stored with computer executable instructions;
the at least one processor executes the computer executable instructions stored in the at least one memory, such that the at least one processor executes a method for identifying underclocking risks in a public cloud, which comprises:
collecting frequency fluctuations of CPU units in a host in a public cloud environment, wherein each of the CPU units comprises a plurality of cores;
collecting CPU utilization rates of tenant virtual machines in the host; and
sifting out risky virtual machines from the tenant virtual machines according to the frequency fluctuations of the CPU units and the CPU utilization rates of the tenant virtual machines.

15. The electric device according to claim 14, wherein the sifting out risky virtual machines from the tenant virtual machines according to the frequency fluctuations of the CPU units and the CPU utilization rates of the tenant virtual machines comprises:
sifting out, from the tenant virtual machines, at least one tenant virtual machine with a CPU utilization rate larger than a preset CPU utilization rate threshold, to determine as the risky virtual machines, in response to the frequency fluctuation of underclocking of any target CPU unit exceeding a preset fluctuation threshold.

16. The electronic device according to claim 14, wherein the method, after the risky virtual machine is sifted out, further comprises:
detecting whether the risky virtual machine is target virtual machine being affected by underclocking according to a preset detection rule.

17. The electronic device according to claim 16, wherein the detecting whether the risky virtual machine is target virtual machine being affected by underclocking according to a preset detection rule comprises:
judging whether a tenant corresponding to the risky virtual machines belongs to a preset tenant set, and if the tenants corresponding to the risky virtual machines belong to the preset tenant set, determining that the risky virtual machine is not the target virtual machine being affected by underclocking; and/or
judging whether the host is exclusive to the risky virtual machines, and if the host is exclusive to the risky virtual machines, then determining that the risky virtual machine is not the target virtual machine being affected by underclocking; and/or
detecting whether the risky virtual machine is the target virtual machine being affected by underclocking according to a number of cores of the target CPU unit used by the risky virtual machine.

18. The electronic device according to claim 17, the detecting whether the risky virtual machine is the target virtual machine being affected by underclocking according to a number of cores of the target CPU unit used by the risky virtual machine comprises:
determining that the risky virtual machine is the target virtual machine being affected by underclocking, if the number of cores of the target CPU unit used by the risky virtual machine is not 0 and smaller than a preset number-of-core threshold; or
ranking, according to the number of used cores of the target CPU unit, the risky virtual machines which number of used cores of the target CPU unit is not 0, and determining, in the ranking, one or more risky virtual machines which use the least number of cores of the target CPU unit, as the target virtual machine being affected by underclocking; or
determining that the risky virtual machines are not the target virtual machine being affected by underclocking, if the number of cores of the target CPU unit used by the risky virtual machines is 0.

19. The electronic device according to claim 16, wherein the method, after determining that the risky virtual machine is the target virtual machine being affected by underclocking, further comprises:
causing the target virtual machines to migrate.

20. A non-transient computer readable storage medium, wherein computer executable instructions are stored in the computer readable storage medium, and the processor, when executing the computer executable instructions, implements a method for identifying underclocking risks in a public cloud, comprising:
collecting frequency fluctuations of CPU units in a host in a public cloud environment, wherein each of the CPU units comprises a plurality of cores;
collecting CPU utilization rates of tenant virtual machines in the host; and
sifting out risky virtual machines from the tenant virtual machines according to the frequency fluctuations of the CPU units and the CPU utilization rates of the tenant virtual machines.
